(19) United States
(12) Patent Application Publication
(10) Pub. No.: US 2019/0298058 A1
(43) Pub. Date: Oct. 3, 2019

(54) MULTI SHEET-MUSIC HOLDER

(71) Applicant: Hal Jay Greene, Denver, CO (US)

(72) Inventor: Hal Jay Greene, Denver, CO (US)

(21) Appl. No.: 16/367,183

(22) Filed: Mar. 27, 2019

Related U.S. Application Data
(60) Provisional application No. 62/649,560, filed on Mar. 28, 2018.
(60) Provisional application No. 62/722,979, filed on Aug. 26, 2018.

(51) Int. Cl. A47B 23/00; B42D 1/10

(52) U.S. Cl. CPC A47B 23/004; B42D 15/008; B42D 1/10

(57) ABSTRACT

A holder is presented for collecting, organizing, and mounting pages of sheet music. The holder includes an elongated sheet made of sturdy and heavy weight paper material divided into a predetermined number of sections by traverse perforation lines. Coupling members are disposed on at least one of the sections such that the pages of sheet music may be mounted over the elongated sheet using the coupling member. The holder may act as a stand for sheet music.

### FIELD OF INVENTION

The present invention relates to a holder for sheet music and in particular relate to a holder for organizing a number of pages of sheet music.

### BACKGROUND AND SUMMARY

“Sheet music”, also known as a “musical score”, is a written or printed form of musical notation. It is mainly used to provide a visual representation of a musical composition which may be read by a musician. Typically, a medium of sheet music is paper and the musical composition is printed or handwritten on the paper. Depending upon the size of the musical composition, the musical composition may extend from one page of sheet music to a number of pages of sheet music. Moreover, the user may have more than one musical composition contained in a number of pages of sheet music.

Collecting, assembling, and organizing multiple pages of sheet music can be a difficult task for the user. Moreover, pages are liable to miss, disarrange and to become soiled, worn, and torn. Thus, a need is appreciated for an apparatus for collecting, assembling, organizing, and protecting multiple pages of sheet music.

It would therefore be advantageous to provide a holder for organizing multiple pages of sheet music.

It would therefore be advantageous to provide a holder for collecting multiple pages of sheet music.

It would therefore be advantageous to provide a holder for assembling multiple pages of sheet music.

It would also be advantageous to provide a holder that prevents pages from becoming soiled, torn or worn.

It would also be advantageous to provide a holder that prevents pages from being disarranged.

It would also be advantageous to provide a holder that acts as a sturdy stand for sheet music.

It would also be advantageous to provide a holder that is light in weight, economical to manufacture, easy to store and transport.

It would also be advantageous to provide a holder that is the exact size to hold any specific number of sheet music sheets.

It would also be advantageous to provide, between sections of the holder, a perforation line including alternating perforated and non-perforated sections to strengthen the perforation line.

Accordingly, in one possible embodiment, an elongated sheet made of sturdy heavy stock paper may be folded accordion-style along traverse lines of perforation into a stack such that a length of any suitable number of sheets may be easily removed by tearing along one of the lines of perforation to form an accordion-folded sheet holder. The traverse lines of perforation may divide the sheet into sections and the pages of the sheet music may be mounted on each section to form a single bound volume and a sturdy music stand for the sheet music.

In another embodiment, a number of two-sided individual sheets of sturdy heavy stock paper are arranged as leaves in a spiral-ring or other type binder. Pages of sheet music may be mounted on respective pages of the leaves of the sheet holder to form a single bound volume and a sturdy music stand for the sheet music.

This summary of features and advantages of one or more embodiments described herein should not be considered to define any claimed invention or to be dispositive in determining equivalence thereof. Additional features and advantages of the invention will become apparent in the following description and from the drawings. These and other features, aspects, and advantages of the present invention will become better understood with reference to the following drawings and description.

### BRIEF DESCRIPTION OF THE DRAWINGS

The accompanying figures, which are incorporated herein, form part of the specification and illustrate embodiments of the present invention. Together with the description, the figures further serve to explain the principles of the present invention and to enable a person skilled in the relevant arts to make and use the invention.

FIG. 1 shows an exemplary embodiment of the present invention as a five-section accordion-folded holder for sheet music.

FIG. 2 shows a stack of accordion-folded continuous elongated sheet according to a possible embodiment of the present invention.

FIG. 3 shows the sturdy five-section accordion-folded holder of FIG. 1 with five pages of sheet music attached.

FIG. 4 is a rear view of the sturdy five-section accordion-folded holder of FIG. 1.

FIG. 5 shows another embodiment of the present invention as a six-sheet accordion-folded sheet music holder.

FIG. 6 shows a possible non-accordion embodiment of the invention in which a number of two-sided individual sheets of sturdy heavy stock paper are arranged in a spiral-ring binder.

FIG. 7 shows the inside of the non-accordion embodiment of FIG. 6.

FIG. 8 shows an embodiment using a hybrid perforation in which hinges (areas of non-perforation) are incorporated into the crease to give the product enough strength to withstand extended reverse folding.

### DETAILED DESCRIPTION

The present invention relates to a holder for sheet music and in particular, relates to a sheet holder for organizing multiple pages of sheet music.

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

Though the claimed invention is envisioned to be used with sheet music, the claims are not to be limited by the purpose for which the invention is used. Thus, the words “sheet music” in the claims are to be understood as including not just literal sheet music pages but also other types of pages, papers, photographs, exhibits, etc. that can be collected, assembled, organized, and/or mounted in the claimed holder.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein (except in the claims), the singular forms “a”, “an” and “the” could include the plural forms as well, unless the context clearly indicates otherwise. It will be further understood that the terms “comprise”, “comprises”, “comprising”, “include”, “includes”, and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

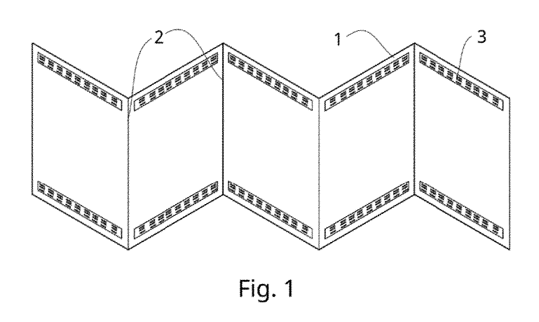

FIG. 1 shows an exemplary embodiment of the holder according to the present invention. The holder as shown in FIG. 1 comprises an elongated sheet 1 made of sturdy, heavy stock paper. The elongated sheet 1 has parallel longitudinal edges on opposite sides thereof running lengthwise thereof. A plurality of traverse perforation lines 2 are spaced along the length of the elongated sheet 1 dividing the elongated sheet 1 into a plurality of sections. The traverse perforation lines 2 extend from the opposite longitudinal edges and substantially perpendicular to them. In FIG. 1, four traverse perforation lines 2 spaced at equal distances along the longitudinal edges divide the elongated sheet 1 into five sections. Further as shown in FIG. 1, the elongated sheet 1 may be folded along the traverse perforation lines 2. The elongated sheet 1 is folded inward and outward in a zigzag fashion to form a stack, similar to accordion-folded sheets. FIG. 1 shows a front face of the elongated sheet 1. Coupling member 3 is disposed on the front face of the elongated sheet 1.

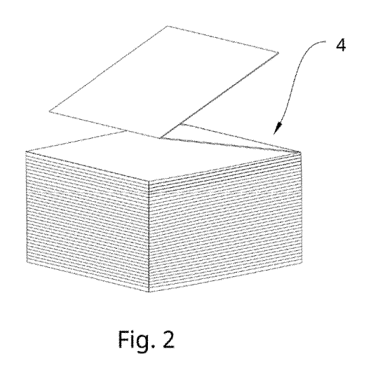

FIG. 2 shows a stack 4 of continuous elongated sheet accordion folded along the traverse perforation lines. The continuous elongated sheet may be of any suitable length and the user may draw the elongated sheet 1 of any desired length from the stack 4 up to the limit of the number of sheets in the stack 4. For example, the user may draw the elongated sheet 1 having five sections, as shown in FIG. 1. The user may simply tear the appropriate traverse perforated line 2 to separate the elongated sheet 1 from the stack. Thus, any length of the elongated sheet 1 may be separated from the stack by tearing carefully along the traverse perforation line 2. The elongated sheet 1 may be made from a sturdy, heavy stock paper, for example, heavyweight/thickness Manila or cover stock paper may be manufactured and perforated in a regular way. Any suitable length of heavy stock paper may be used.

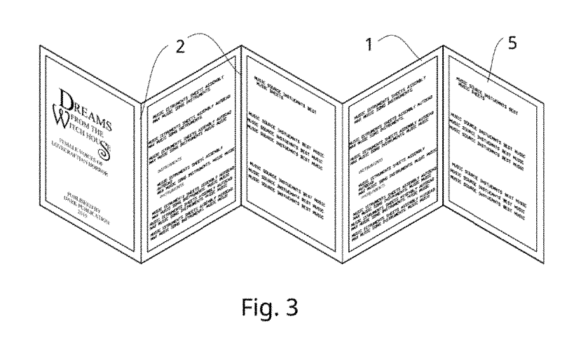

FIG. 3 shows pages of the sheet music mounted over the front face of the elongated sheet 1. The height of the elongated sheet 1 and the distance between traverse perforation lines 2 may be of a suitable dimension such that the pages of sheet music or any other desired media, for example, printed media, may be mounted. The pages of sheet music are mounted using respective coupling members 3 (not visible in FIG. 3) behind each respective sheet of the media. The coupling members 3 may be an adhesive, tape, mechanical coupler, or the like, or any combination thereof, for removably or non-removably mounting a paper over a sheet. Moreover, the coupling member may be protected using a wax-paper or like, which may be removed before mounting the page of sheet music. As may be seen in FIG. 1, the mounting tape may be affixed to various areas, for instance at the top and the bottom, of each section of the accordion folded sheet holder.

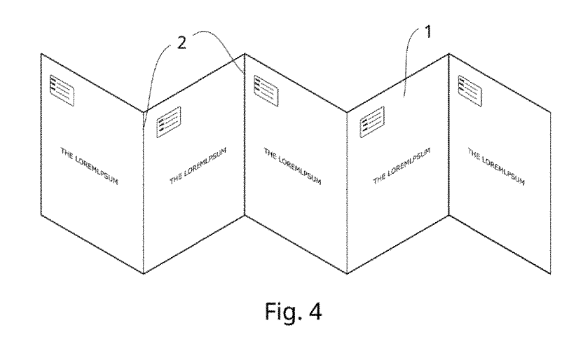

FIG. 4 shows the rear side of the holder of FIG. 1. In this embodiment, the rear side of the elongated sheet 1 may be printed to include an area for labeling and/or other information, an area for a brand name or other design, or any other type of printing desired, or may be left with no printing on it.

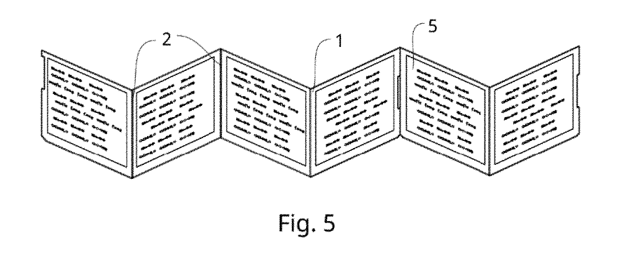

FIG. 5 shows another embodiment of the present invention, which is an accordion folded sheet holder with six sections. The holder has 5 traverse perforation lines 2 and the elongated sheet 1 may be folded in a zigzag fashion allowing the holder to also act as a stand for sheet music. In an alternate embodiment, the holder according to the present invention may also be used to mount other types of media, such as text, photograph, and like.

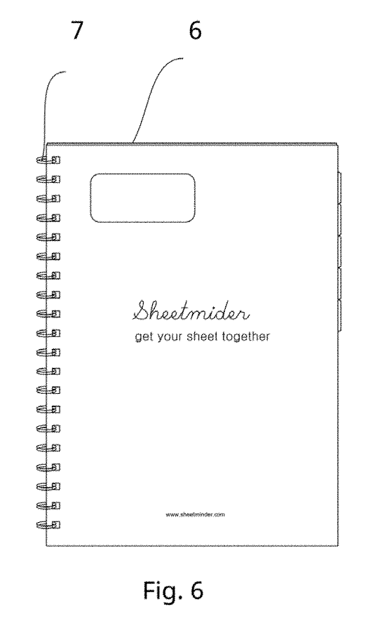

FIG. 6 shows an alternate embodiment in which a number of individual sheets 8 of the heavy stock paper may be arranged within a spiral binder 6. The individual sheets 8 are coupled using spiral coupling 7. In these embodiments, the front and back cover of the spiral binder 6 may include an area for a cover page including a brand name or other design, or any other type of printing desired.

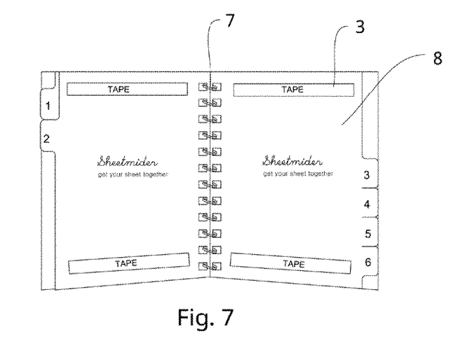

As seen in FIG. 7, each side of the individual sheets 8 within the spiral binder 6 may have mounting tape (for example) mounting couplers 3 affixed to various areas, for instance at the top and the bottom, of each sheet 8, and may include an area for labeling and/or other information, an area for a brand name or other design, instructions, and/or any other type of printing desired, as well. Moreover, the separate pages of sheet music, text, drawings, photographs, or any other type suitable media, may be collected within a spiral binder 6.

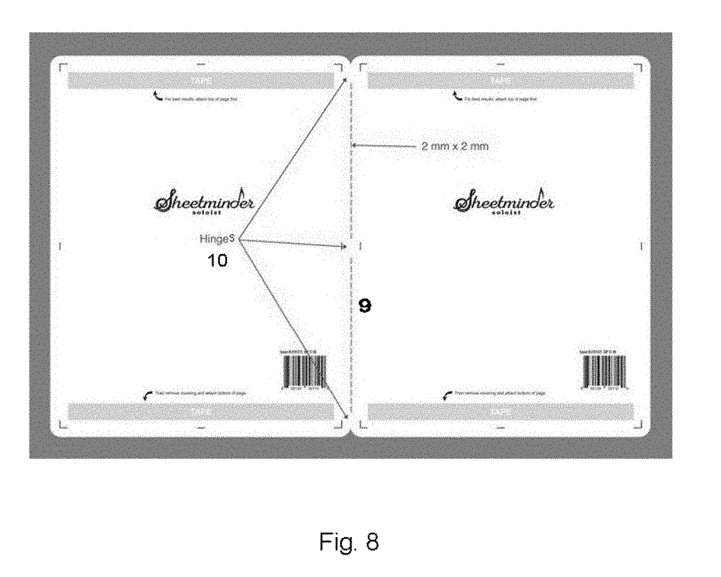

As seen in FIG. 8, a hybrid perforation or semi-perforation line 9 including hinges 10 (areas of non-perforation) may be incorporated into the crease to give the product enough strength to withstand extended reverse folding.

### COMMERCIAL APPLICABILITY

It may be seen that by means of the invention, a sturdy heavy-stock “sheet music stand” for any desired number of sheets may be taken from the stack of accordion-folded heavy stock paper and separated by means of the perforations. The perforations also serve to allow the various sections of the heavy stock sheet music stand to be partially folded at the perforations in order to allow the sturdy sheet music stand to stand up for viewing, for example on the music desk of a piano or a standalone music stand of the type commonly used in an orchestra or by a musician.

The perforations also allow the sheet music stand to be completely folded for easy storage, for example in the sheet music storage area of a piano bench, while not being used.

By appropriate choice of mounting tape or other possible mounting strips or adhesive “dots” as mounting couplers 3 the sheet music attached to the accordion-folded music stand may be removed and replaced with other sheet music, or a separate section may be removed from the stack in order to display the new sheet music.

Non-accordion embodiments may be made with the sheets contained within a spiral or similar type of notebook. Embodiments outside of the sheets may have the mounting tape or other possible mounting strips or “dots” by which sheet music meeting attached to and removed from any number of sheets.

The above advantages and features are of representative embodiments only and are not exhaustive and/or exclusive. They are presented only to assist in understanding the invention. It should be understood that they are not representative of all the possible embodiments of the invention, and are not to be considered limitations on the invention, which will be defined by the claims of any resulting patent, and are not to be considered limitations on equivalents to the claims. For instance, some of these advantages may be mutually contradictory, in that they cannot be simultaneously present in a single embodiment. Similarly, some advantages are applicable to one aspect of the invention and inapplicable to others. Furthermore, certain aspects of the claimed invention have not been discussed herein. However, no inference should be drawn regarding those discussed herein relative to those not discussed herein other than for purposes of space and reducing repetition. Additionally, terms are to be understood with reference to the subject matter. For example, “sturdy” when referring to the sheets of the heavy stock paper may be understood as relative to the flimsiness of an ordinary piece of writing paper or paper on which sheet music is usually printed.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

I claim:

1. A holder for sheet music, comprising:
an elongated sheet having a front face, a rear face, and parallel longitudinal edges on opposite sides thereof and extending lengthwise thereof;
a plurality of transverse perforation lines extending from the longitudinal edges, substantially perpendicular thereof and spaced along the length of longitudinal edges dividing the elongated sheet into a plurality of sections, the elongated sheet being accordion-folded along the plurality of transverse perforation lines; and
a respective coupling member disposed on the front face of each of the plurality of sections, each said respective coupling member adapted to mount a respective page of sheet music to each respective one of said plurality of sections.

2. The holder of claim 1, including a plurality of said pages of sheet music respectively mounted to the plurality of sections.

3. The holder of claim 1, wherein the coupling member is an adhesive.

4. The holder of claim 1, wherein the coupling member is a tape.

5. The holder of claim 1, including removable means for protecting the coupling members until said pages of sheet music are to be mounted.

6. The holder of claim 5, wherein said removable means for protecting the coupling members is wax paper.

7. The holder of claim 1, wherein the holder comprises at least five sections.

8. The holder of claim 1, wherein the elongated sheet is made of heavyweight and sturdy paper, permitting the holder to act as a stand for the sheet music.

9. A holder for a sheet music, comprising:
an elongated sheet having a front face, a rear face, and parallel longitudinal edges on opposite sides thereof and extending lengthwise thereof;
a plurality of transverse semi-perforation lines extending from the longitudinal edges, substantially perpendicular thereof and spaced along the length of longitudinal edges dividing the elongated sheet into a plurality of sections, the elongated sheet being accordion-folded along the plurality of transverse perforation lines,
each of said semi-perforation lines comprising one or more perforated line segments alternating in a linear fashion with one or more non-perforated segments; and
a respective coupling member disposed on the front face of each of the plurality of sections, each said respective coupling member adapted to mount a respective page of sheet music to each respective one of said plurality of sections.

10. The holder of claim 9, each of said semi-perforation lines including a plurality of perforated line segments alternating in a linear fashion with one or more non-perforated segments.

11. The holder of claim 9, each of said semi-perforation lines including one or more perforated line segments alternating in a linear fashion with a plurality of non-perforated segments.

12. The holder of claim 9, each of said semi-perforation lines including a plurality of perforated line segments alternating in a linear fashion with a plurality of non-perforated segments.

13. The holder of claim 9, including a plurality of said pages of sheet music respectively mounted to the plurality of sections.

14. The holder of claim 9, wherein the coupling member is an adhesive.

15. The holder of claim 9, wherein the coupling member is a tape.

16. The holder of claim 9, including removable means for protecting the coupling members until said pages of sheet music are to be mounted.

17. The holder of claim 16, wherein said removable means for protecting the coupling members comprises wax paper.

18. The holder of claim 9, wherein the holder comprises at least five sections.

19. The holder of claim 9, wherein the elongated sheet is made of heavyweight and sturdy paper, permitting the holder to act as a stand for the sheet music.

20. A holder for sheet music comprising:
a plurality of sheets spirally bound together at one of the edges thereof and a respective coupling member disposed on both front and rear faces of the plurality of sheets, such that a respective page of sheet music may be mounted on each respective one of the plurality of sheets,
the plurality of sheets being made of heavyweight and sturdy paper, permitting the holder to act as a stand for the sheet music.
